(19) United States
(12) Patent Application Publication
(10) Pub. No.: US 2011/0029383 A1
(43) Pub. Date: Feb. 3, 2011

(54) SYSTEM AND METHOD FOR PROVIDING ADVERTISING CONTENT VIA AN INTEGRATED HOME BASED DEVICE

(76) Inventors: Randy Engel, Grapevine, TX (US); Darren Collins, Grapevine, TX (US)

Correspondence Address: SNR DENTON US LLP, P.O. BOX 061080, CHICAGO, IL, 60606-1080, US

(21) Appl. No.: 12/510,645

(22) Filed: Jul. 28, 2009

(51) Int. Cl. G06Q 30/00; G06F 3/041

(52) U.S. Cl. 705/14.53; 705/14.58; 705/14.69; 345/173

(57) ABSTRACT

Certain of the disclosed embodiments present a system and method for providing in-home targeted advertisements to individual consumers. For instance, the disclosed embodiments include an in-home advertising device that enables a user to interact with the in-home advertising device and purchase items with the push of a button. Additionally, in some embodiments, the in-home advertising device may include a built in printer for enabling a user to print an advertised and/or coupon.

### BACKGROUND OF THE INVENTION

The disclosed embodiments are related to the field of advertising. Advertising is a form of communication that attempts to persuade potential customers to purchase a particular brand of product or service. Many forms of advertising exist including, but not limited to, television and radio commercials, infomercials, emails, newspapers, posters, billboards, and mass mailing of flyers. However, the majority of these types of advertisements are largely ignored by consumers. For example, with the advent of digital video recorders, the majority of television commercials are skipped during replay. Additionally, the majority of flyers received via mail are discarded immediately without the consumer taking notice of the advertisement. Further, these types of advertisements do not provide a convenient way to target a consumer's specific interest. Accordingly, the disclosed embodiments provide a system and method for providing advertising content to a consumer via an integrated home based device that overcomes one or more of the above identified problems.

### SUMMARY OF THE INVENTION

Certain of the disclosed embodiments provide an in-home advertising device to individual consumers which will enable targeted offers. In some embodiments, the in-home advertising device utilizes a touch screen device for enabling a user to interact with the in-home advertising device. Additionally, in some embodiments, the in-home advertising device may include a built in printer for enabling a user to print an advertisement or coupon.

In certain embodiments, the in-home advertising device may contain an intuitive delivery interface that enables an individual consumer to choose content and/or receive targeted offers. In one embodiment, advertising partners target potential customers and provide varying levels of restitution based on the level of user activity and type of interaction.

Advantages of one or more of the disclosed embodiments include, but are not limited to, overcoming the current barriers to the mass appeal of mobile handset advertising while providing the inherent benefits. For example, in one or more embodiments, the in-home advertising device may facilitate a consumer's spending preferences and save the consumer money without being intrusive. One or more of the disclosed embodiments embrace and leverage the recent sentiment of “Going Green” (e.g., unwanted newspapers, flyers, mailers may be eliminated) and help consumers through challenging economic times. In one embodiment, the device is intended to be available in plain view and to provide easy access within the household (e.g., resting on a kitchen counter) and become a normal fixture of the residence. In addition, in one embodiment, the in-home advertising device is convenient in that it eliminates the need for a consumer to “log-in” or engage directly with a content server (i.e., push versus pull). Further, in certain embodiments, the in-home advertising device eliminates the need to “search” by automatically receiving the advertisements based on one or more user profiles or configuration settings. However, if desired, in some embodiments, the in-home advertising device may include search capabilities for locating a particular good or service.

Additionally, in some embodiments, the in-home advertising device receives daily updates for providing new offers in near real time. In some embodiments, the in-home advertising device may include data mining capabilities for automatically enabling the delivery of focused offers driven by a user's interaction with the in-home advertising device. In addition, in some embodiments, the in-home advertising device may provide advertisements based on the home location of the in-home advertising device and/or provide advertisements associated with businesses that are located along a commonly traveled route. For instance, wireless capability by location of device allows for targeted offers at any level of detail (user profile, state, city, zip, neighborhood and street). The in-home advertising device may update content choices as experience grows with system attributes and as new content providers are added. Content providers may fund execution by paying for various levels of utilization such as delivery of message views, an additional premium for printed offers, a premium for actual redemptions, as well as paying for data on consumer usage or profiles.

In certain embodiments, the in-home advertising device includes the capability for printing coupons that include information for identifying the particular in-home advertising device that printed the coupon. For instance, this information may be used for tracking coupon usage, eliminating fraud, and performing market research. Further, in certain embodiments, the waste stream associated with traditional methods of delivery of offers, e.g., newspapers, flyers, and mailers, may be eliminated.

Certain of the disclosed embodiments provide a distinct advantage and ability to overcome limitations over the current forms of wireless advertising. For example, the small screen size of a typical mobile handset is not user friendly for extended utilization and limits content display. In a preferred embodiment, the use of an in-home advertising device allows for a large touch screen which is fixed and viewable without having to hold or manipulate a smaller device's user interface. In addition, the touch screen may allow for the capability of full content display. Further, mobile handset consumers may acquire additional charges in connection with receiving unwanted text, data, or audio advertisements. Accordingly, certain of the disclosed embodiments provide for content delivery which is separate from any existing mobile handset pricing plan. Additionally, in one embodiment, the in-home advertising device receives content during off-peak hours or traffic times and stores the received content in memory. This enables a user to interact with the in-home advertising device without experiencing a slowdown in performance.

One or more of the disclosed embodiments create a seamless new revenue stream for the carrier partner while filling the gap from a network utilization perspective. In addition, privacy and personalization concerns inherent with a mobile handset may be reduced due to the fact that certain embodiments utilize a separate device for the specific purpose of facilitating the delivery of offer content. The in-home advertising device by default will therefore not intrude on or overlap with the private space inherent in the connection with the consumer's utilization of a wireless device.

Further, certain of the disclosed embodiments include the capability to ensure delivery and confirmation of viewing. For instance, in some embodiments, the in-home advertising device may track the printing of an offer, the redemption of an offer, or other user interaction with a particular advertisement or offer. In one embodiment, the in-home advertising device provides feedback to a network server on a daily basis by virtue of the continuous connection via the existing wireless networks.

### BRIEF DESCRIPTION OF THE DRAWINGS

Illustrative embodiments of the present invention are described in detail below with reference to the attached figures, which are incorporated by reference herein and wherein:

FIG. 1 depicts an embodiment of a network environment in which certain illustrative embodiments of the invention may be implemented;

FIG. 2 depicts internal components of an embodiment of an in-home advertising device in accordance with certain embodiments of the invention;

FIG. 3 depicts an external view of an embodiment of an in-home advertising device in accordance with certain embodiments of the invention;

FIG. 4 depicts an embodiment of a process for providing advertising content to an m-home advertising device in accordance with certain embodiments of the invention; and

FIG. 5 depicts an embodiment of a process for providing advertising content to a consumer in accordance with certain embodiments of the invention.

### DETAILED DESCRIPTION OF THE DRAWINGS

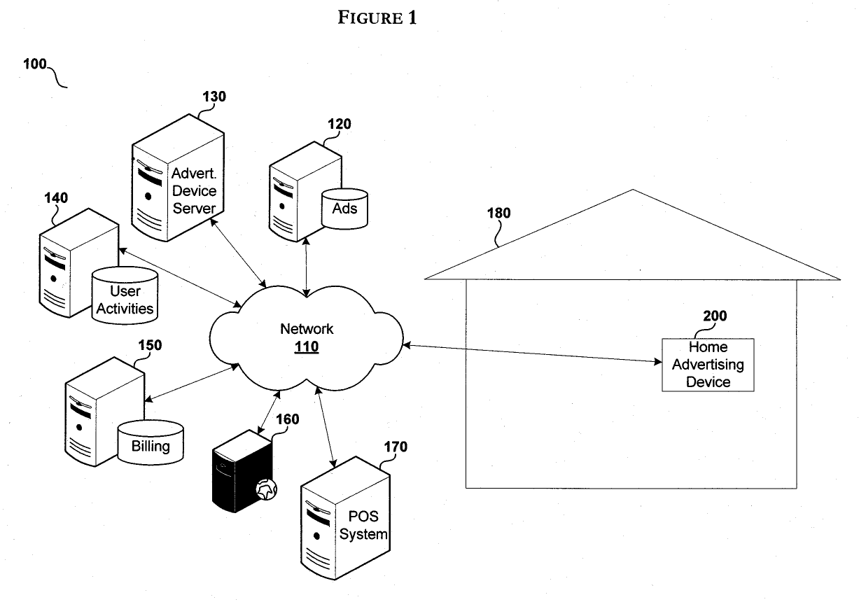

The disclosed embodiments and advantages thereof are best understood by referring to FIGS. 1-5 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and not intended to assert or imply any limitation with regard to the environment, architecture, design, or process in which different embodiments may be implemented.

FIG. 1 depicts an embodiment of a network environment 100 in which certain illustrative embodiments may be implemented. In one embodiment, an in-home advertising device, such as, but not limited to, in-home advertising device 200 is configured to receive advertising content from one or more network devices. As referenced herein, an in-home advertising device is defined as an electronic device that is utilized only within a home environment, such as, residential location 180, for the purpose of presenting advertisements/offers to a consumer. In-home advertising device 200 may be placed within any location within residential location 180. In a preferred embodiment, in-home advertising device 200 is placed in an open viewable space that is nonintrusive to a consumer, including, but not limited to, a kitchen counter. In some embodiments, in-home advertising device 200 is always on and/or may be configured to turn on and off at predefined, user-specified, or carrier-specified times. In other embodiments, a user may manually turn in-home advertising device 200 on and off as desired.

In a preferred embodiment, in-home advertising device 200 includes a wireless transceiver for receiving advertising content from one or more sources, including, but not limited to, a advertising device server 130 via network 110. Alternatively, as will be further described, in some embodiments, in-home advertising device 200 may include a wired network component, such as, but not limited to, an Ethernet network card and/or telephone modem for facilitating data transfer.

In one embodiment, network 110 is a cellular telephone network and in-home advertising device 200 communicates with cellular telephone network using a cellular communications protocol such as GSM or CDMA. In such an embodiment, in-home advertising device 200 may be assigned its own subscriber identity module (SIM) and associated SIM card. The SIM may include a mobile subscriber number such as an international mobile subscriber identity (IMSI). As described in further detail below, in this one embodiment, the use of a cellular network during off-peak periods of relative network inactivity allows wireless carriers to offer an advertising service pursuant to the teachings of the present invention with no additional bandwidth over the requirements of their current network and subscriber base. Such an embodiment allows wireless service providers to enhance revenue through the collection of advertising fees without any increase in infrastructure deployment or the expansion of their base of consumers. The use of a separate device and SIM card from a consumer's mobile telephone allows advertising content and collected advertising behavior to isolated from other personal information a consumer may store or create on their mobile telephone.

As referenced herein, network 110 may include one or more data networks, such as, but not limited to, the Internet, for routing communications between one or more communication devices and/or data processing systems. The Internet is a global system of interconnected computer networks that interchange data using the standardized Internet Protocol Suite (TCP/IP). In some embodiments, network 110 may include other types of data networks, such as, but not limited to, an intranet, a private local area network (LAN), a wide area network (WAN), and a wireless local area network (WLAN). In addition, in some embodiments, network 110 may include one or more cellular networks and/or a landline telephone networks for routing data between advertising device server 130 and other network devices. For example, in some embodiments, network 110 may include one or more GSM networks, CDMA networks, Enhanced Data GSM Environment (EDGE) networks, PSTN networks, and 3G/4G networks for facilitating data communications between the network devices/systems.

In one embodiment, in-home advertising device 200 may communicate directly, or indirectly through a WLAN or other access network, with a DSL, cable, or fiber network such as those used to deliver residential telephone, cable television, or Internet access to a home. Again, by utilizing such networks during off-peak periods of relative network inactivity, the needs of in-home advertising device 200 may be met without any increase in cost or network bandwidth.

In certain embodiments, in-home advertising device 200 collects feedback associated with a user's interaction and transmits the feedback to advertising device server 130 for facilitating dynamic advertising content based on a user's interest. In one embodiment, advertising device server 130 may store the data associated with a user's interaction with in-home advertising device 200 on a network database, such as, but not limited to, user activities database 140 of FIG. 1. Alternatively, in some embodiments, a user may configure in-home advertising device 200 to only retrieve/display advertisements relating to a particular category, store, brand, venue, and/or within a certain distance of a home location or alternative location associated with in-home advertising device 200.

In one embodiment, in-home advertising device 200 may communicate with a central server such as advertising device server 130. Advertising device server 130 may be a specially configured data processing system that provides personalized advertising content to one or more in-home advertising devices located within a plurality of homes. For instance, in one embodiment, advertising device server 130 may communicate with an advertisement database 120 for retrieving personalized advertisements based on a user profile and/or based on a user's interaction history. In one embodiment, advertising device server 130 transmits advertisements to in-home advertising device 200 only during off peak traffic times, such as, but not limited to, during the night. In such an embodiment, advertising device server 130 may monitor network traffic to assess available bandwidth between the individual in-home advertising device 200 and advertising device server 130 or another server providing ad content, for example. When such monitoring identifies an available window of bandwidth availability, advertising device server 130 may initiate an update process with in-home advertising device 200. Such monitoring may include the monitoring of line state, trunk state, packet loss, available bandwidth, latency, jitter, or any other metric of network availability or utilization. In one embodiment, a batched update process may be scheduled during known periods of network inactivity, such as 2 a.m. local time, or during such known periods of network inactivity unless a network fault or other performance condition has been identified in a network such as network 110.

In addition, in some embodiments, advertising device server 130 may facilitate the purchasing of goods or services associated with a particular advertisement. For instance, in some embodiments, a consumer may purchase goods and/or services using in-home advertising device 200 by transmitting a buy request to advertising device server 130. In these embodiments, advertising device server 130 may identify the user associated with the transmitting in-home advertising device 200 (e.g., using subscriber information associated with in-home advertising device 200), retrieve payment information associated with the identified user (e.g., stored credit card information), verify the transaction (e.g., the user must enter a pin/password using in-home advertising device 200), and place the order with a vendor (e.g., using a web site hosted by Web server 160). In addition, in some embodiments, advertising device server 130 may communicate with a billing server 150 for billing the vendor (i.e., the vendor pays a percentage and/or flat fee to the company that provides the in-home advertising device/service).

Similarly, as will be further described, in some embodiments, in-home advertising device 200 may include a built-in printer component for enabling a user to print a coupon associated with a particular advertisement offer. In one embodiment, the printed coupon may include embedded data, e.g., in the barcode, redemption code, printed RFID device, or other identifier that identifies the particular in-home advertising device or individual consumer that printed the coupon (referred to hereafter as (“consumer identifier”). In various embodiments, the consumer identifier may be a SIM card number, mobile identifier, telephone number, or customer account number. This particular feature may be used for tracking coupon usage, eliminating fraud, and conducting market research. For example, by using the consumer identifier, an advertiser may determine whether a coupon that is printed is redeemed, how long it took to redeem a coupon from the time of printing, and the demographics associated with consumers that utilize a particular coupon. For instance, in one embodiment, a point-of-sale (POS) data processing system 170 may report the use of a coupon generated by in-home advertising device 200 to advertising device server 130. In these embodiments, advertising device server 130 may match the embedded data on the coupon to a user profile for generating a market research analysis report as a paid service to the vendors/businesses. In some embodiments, advertising device server 130 may communicate with billing server 150 for billing a particular vendor/business based on the usage of a coupon.

In addition to being used to track coupon usage, collect market research, and bill advertisers, the consumer identifier may be utilized to assess the usage of in-home advertising device 200 by each consumer for billing purposes under various payment models. For example, in one embodiment a payment model may be utilized that offer the advertising service and associated in-home advertising device 200 to a consumer or household without charge, provided that they utilize so many coupons each billing period, spend so much money at advertisers during such billing period, or otherwise satisfy some other threshold associated with a metric of usage, spending, or redemption. Such threshold may be associated with a perceived break-even point or required revenue metric of either a service provider such as a wireless carrier or a company providing the advertising service itself. Such threshold may also be associated with a return on investment associated with the cost of in-home advertising device 200 itself In one embodiment, a consumer is charged a marginal monthly fee for any month in which their usage of in-home advertising device 200 does not exceed an established threshold.

FIG. 1 is intended to illustrate only one network architecture in accordance with the disclosed embodiments. The disclosed embodiments may be implemented with other types of network architecture. For instance, in some embodiments, in-home advertising device 200 may communicate directly with one or more of the network devices/systems, such as, but not limited to, advertisement database 120, billing server 150, and/or Web server 160 for providing advertising content to a consumer and facilitating the sale of goods or services to consumer without the use of a central server.

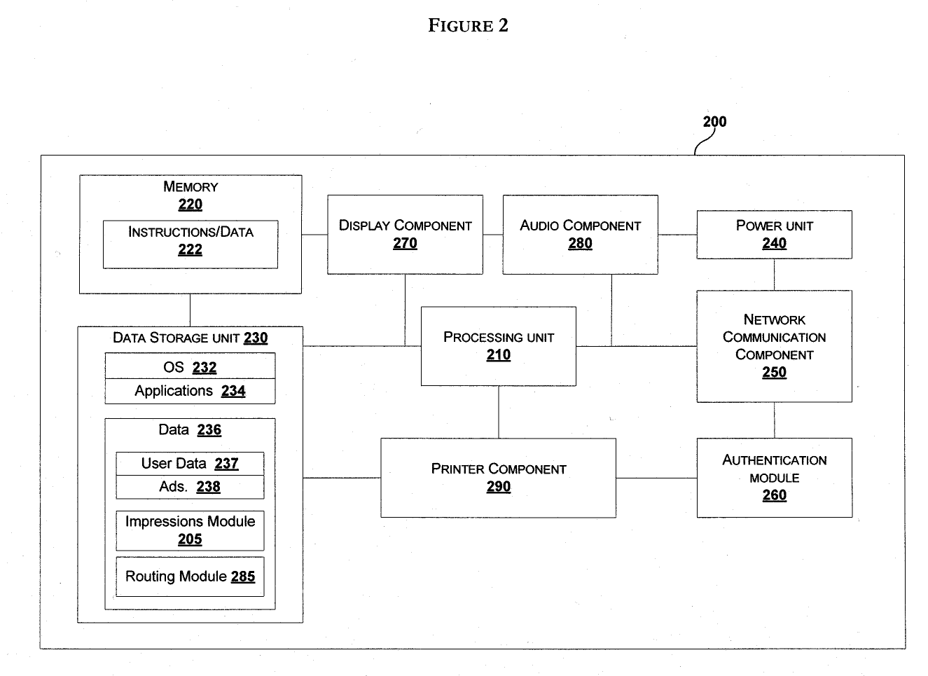

FIG. 2 depicts internal components of an embodiment of in-home advertising device 200 in accordance with certain embodiments of the invention. In the depicted embodiment, in-home advertising device 200 includes, but is not limited to, a processing unit 210, a memory component 220, data storage unit 230, a network communication component 250, an authentication module 260, a display component 270, an audio component 280, and a printer component 290. In one embodiment, the depicted components communicate using conductive pathways, or traces, etched from copper sheets laminated onto a non-conductive substrate. However, in alternative embodiments one or more components may be integrated on a printed circuit board, application specific circuit, microprocessor, microcontroller, multi-chip module, or other combination of systems or components.

Processing unit 210 is operable to execute computer executable instructions stored in memory 220 and/or data storage unit 230. In one embodiment, processing unit 210 may include one or more processing cores, such as, but not limited to, a microcontroller, microprocessor, or a graphics processing unit, for executing instructions and processing data for providing advertising content to a consumer and for facilitating feedback to advertising device server 130.

In one embodiment, memory 220 is volatile memory. Volatile memory is memory that requires power to maintain stored information. For example, in some embodiments, memory 220 may be random access memory (RAM). Random access memory stores currently executing instructions and/or other data 222 utilized by an operating system 232, software applications 234 and/or other components of in-home advertising device 200. Alternatively, memory 220 may be or include nonvolatile memory.

In one embodiment, in-home advertising device 200 includes nonvolatile memory such as data storage unit 230. For example, in one embodiment, data storage unit may be a hard drive. In other embodiments, data storage unit 230 may be flash memory, such as, but not limited to, an xD (extreme Digital) card, SD (Secure Digital) card, or mini SD card. In some embodiments, data storage unit 230 may be removable and/or an interchangeable with other devices. Additionally, in some embodiments, data storage unit 230 may store computer executable instructions, such as, but not limited to, operating system 232, software applications 234. In addition, in some embodiments, data storage unit 230 may store other types of data 236 including, but not limited to, a user data file 237 and advertisements 238. In some embodiments, user data file 237 may include user configuration settings/preferences, a user profile, user interactivity data, and billing information.

In some embodiments, advertisements 238 may include passive and/or interactive advertising content. In a preferred embodiment, advertisements 238 are updated on a daily basis during off-peak hours. By storing advertisements 238 locally, in-home advertising device 200 provides fast display and interactive response times to a consumer. In addition, by retrieving advertisements 238 during off peak hours, in-home advertising device 200 is able to communicate with network devices in real time, if necessary, without the traffic congestion caused by the downloading of advertising content. The use of off-peak hours may further reduce or eliminate any incremental costs of deploying an advertisement service to a network provider such as a wireless carrier as excess network capacity exists during off-peak hours.

Display component 270 provides a means for displaying advertising content to a consumer. Display component 270 may use LCD, LED, OLED, plasma, electronic ink technologies, or other suitable display technology for displaying advertising content to a consumer. In a preferred embodiment, display component 270 includes touch screen capabilities for enabling a user to interact with in-home advertising device 200 by touching the screen. For example, as will be further described, in some embodiments, in-home advertising device 200 may display one or more soft keys for enabling a user to select features associated with in-home advertising device 200 and/or an advertisement. In addition, in some embodiments, in-home advertising device 200 may include audio component 280 for providing audio to a consumer, such as, but not limited to, voice interactivity and/or audio associated with advertising content.

In addition, in-home advertising device 200 may also include a power unit, such as, power unit 240. In one embodiment, power unit 240 converts the input power from an AC adaptor to run various components of in-home advertising device 200. In addition, in some embodiments, power unit 240 may include an internal power source, such as, but not limited to, a battery.

In one embodiment, network communication component 250 includes a wireless transceiver for receiving advertising content from one or more sources, such as, but not limited to, a advertising device server 130 via network 110. For instance, in one embodiment, network communication component 250 may communicate wirelessly with a 3G network for retrieving advertising content. Alternatively, in some embodiments, network communication component 250 may communicate via a wireless Internet router/access point for accessing network 110. Further, in some embodiments, network communication component 250 may include a wired network component, such as, but not limited to, an Ethernet network card and/or telephone modem for facilitating data transfer via a cable connection.

In one embodiment, in-home advertising device 200 includes an impressions module 205. Impressions module 205 stores information with regard to which advertisements are presented on in-home advertising device 200. Impressions module 205 may also store information with regard to which advertisements are selected by a user, flagged for later follow-up, printed, or redeemed with a merchant. Such categories of information may be referred to generally as impressions relative to when they are performed on a particular advertisement. Impressions module 205 may store impressions information relative to each advertisement presented over in-home advertising device 200, providing a useful tool for an operator of advertising services or a merchant to ascertain the interests of a consumer and the appeal of certain advertisements. Impressions module 205 may also store cumulative information on impressions relative to the consumer to gauge the extent to which the consumer is utilizing in-home advertising device 200. In one embodiment, in-home advertising device has a different access button for each member of the household allowing impressions for each household member to be tracked and advertisers to target particular advertisements to particular members of the household. In such an embodiment, the consumer identifier referred to herein may include individual household member identifiers specific to an individual.

In certain embodiments, in-home advertising device 200 may include authentication module 260. Authentication module 260 may comprise hardware, software, and/or a combination thereof for authenticating/identifying in-home advertising device 200 to a third party. For instance, in one embodiment, authentication module 260 may be used to encrypt and/or decrypt a data sequence for verifying the authenticity of in-home advertising device 200. For example, in some embodiments, authentication module 260 may be used to authenticate in-home advertising device 200 as part of a consumer purchase request.

In one embodiment, in-home advertising device 200 may also include a routing module 285. In one embodiment, routing module 285 is an application specific integrated circuit or portion thereof. Alternatively, routing module 285 may include logic and memory executable and accessible respectively by a processor or controller. Routing module 285 stores location information associated with one or more users of in-home advertising device. For example, routing module 285 may store a home location that designates the address where in-home advertising device 200 is located. Routing module 285 may also store work or school addresses where the members of a household frequently travel to and from. Routing module 285 may also store addresses of friends or relatives. Routing module 285 may also store locations associated with scheduled appointments or calendar entries for one or more members of the household. Routing module 285 may utilize an interface such as an XML interface where data from other applications such as calendar and appointment applications may be received and translated into location information suitable for storage by routing module 285. Routing module 285 may also store information on one or more routes between each of the stored locations. Such routes may include information on streets traveled, intersections encountered, freeways utilized, preferences for highways or non-highways utilized, preferences on toll-road usage, or any other suitable information on a route taken or directions therefor. For example, routing module 285 may store route information between a home location and each of the other stored locations, referred to herein as primary routes. Routing module 285 may also store information between each of the other stored locations and each other, referred to herein as secondary routes. Secondary routes take into account the fact that when traveling to or from a stored location, a consumer may not necessarily be traveling directly to or from a home location. Instead, a parent may travel from work to a school. Likewise, a child may travel from school to gymnastics practice. Each of the locations and routes may be used to target advertising to the in-home advertising device 200 by merchants that happen to have locations at such locations or along such routes. Routes can be combined with day of the week, date of the month, or time of day logic to present advertisement via in-home advertising device 200, particularly when combined with knowledge obtained from a calendar or appointment application. Routing module 285 may include its own mapping software or may interface with a remote mapping software or search engine application. In one embodiment, routing module 285 is located remote from in-home advertising device 200 at advertising device server 130 or elsewhere.

Additionally, in one embodiment, in-home advertising device 200 includes a built in printer component 290. Printer component 290 may utilize any type of suitable print technology including, but not limited to, ink-jet, laser, dot-matrix and thermal printers. In one embodiment, in-home advertising device 200 may indicate to a service provider or operator of an advertising service when in-home advertising device 200 is running low on consumables such as ink or paper. For example, advertising device server 130 may receive a message from in-home advertising device 200 when an ink level or spooled paper roll has fallen below a predetermined threshold. Optical and other sensor mechanisms are well known in the printing art that could be adapted for this purpose. Such message may automatically trigger the ordering and shipment of such consumables through an automated inventory retrieval or fulfillment system to the address associated with in-home advertising device 200.

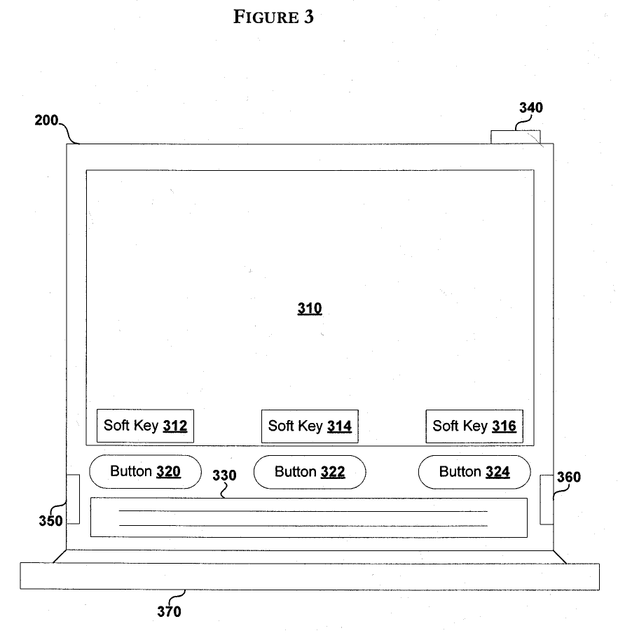

FIG. 3 depicts an external view of an embodiment of in-home advertising device 200 in accordance with certain embodiments of the invention. In the disclosed embodiment, in-home advertising device 200 includes a touch screen display 310. Touch screen display 310 enables a user to interact with in-home advertising device 200 by simply touching certain displayed areas of the screen. In one embodiment, in-home advertising device 200 includes an antenna 340 or other interface for communications with various networks and devices. For example, in one embodiment, in-home advertising device 200 may display one or more soft keys, such as, but not limited to, soft key 312, soft key 314, and soft key 316 associated with a user interface of in-home advertising device 200. In some embodiments, soft key 312, soft key 314, and soft key 316 may be associated with static functions/features associated with in-home advertising device 200. In other embodiments, the functions/features associated with soft key 312, soft key 314, and soft key 316 may dynamically change based on the user interface of in-home advertising device 200 and/or based on a displayed advertisement.

In addition, in some embodiments, in-home advertising device 200 may include one or more hard keys (i.e., physical keys), such as, but not limited to, button 320, button 322, and button 324. In these embodiments, button 320, button 322, and button 324 may be associated with set features or functions associated with in-home advertising device 200. For instance, in one embodiment, button 320, button 322, and button 324 may respectively be a “Print” button, a “Buy” button, and a “More Info” button.

In the depicted embodiment, in-home advertising device 200 includes a printer component 330 below the set of hard keys. However, in other embodiments, printer component 330 may be placed anywhere on in-home advertising device 200 including, but not limited to, above the set of hard keys, above the display screen, and/or to either side of in-home advertising device 200.

Additionally, in one embodiment, in-home advertising device 200 may include one or more visible speakers 350 for outputting audio associated with the user interface of in-home advertising device 200 and/or audio of advertisements. In addition, in some embodiments, in-home advertising device 200 may be supported by an adjustable stand 370.

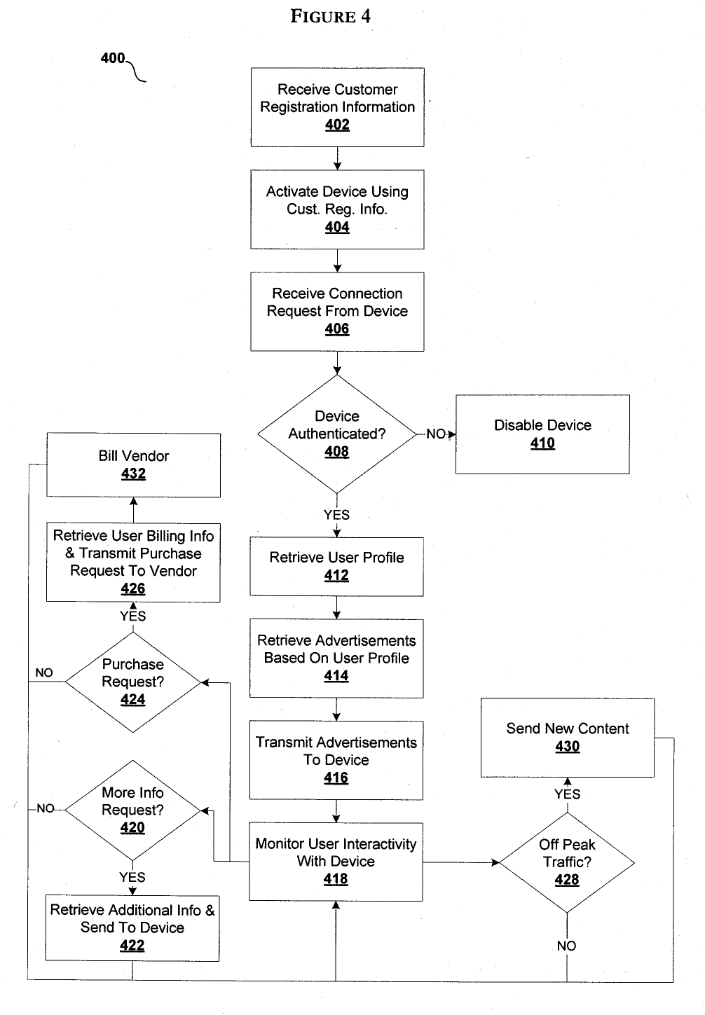

With reference now to FIG. 4, a process 400 for providing advertising content to an in-home advertising device is depicted in accordance with the illustrative embodiments. Process 400 may be executed by a data processing system or network server, such as, but not limited to, advertising device server 130. Process 400 begins by receiving customer registration information at step 402. For instance, in one embodiment, the network server receives the customer information including, but not limited to, a user's name, address, and billing information via a user entering the information into a Web site, or via a store sales personnel entering the information to a network data processing system, and/or via a call center support technician receiving the information from a user over the telephone or from previously existing customer account information. Once the information is entered and verified, in step 404, the process activates an in-home advertising device, such as in-home advertising device 200, using the consumer registration information.

The process then waits for a connection request from the activated in-home advertising device. For example, the in-home advertising device may be mailed to a user's home address and/or a user may pickup an in-home advertising device from a particular retailer. In either case, once the activated in-home advertising device is taken home and turned on, the in-home advertising device transmits a connection request to the network server via a network. At step 406, the process receives the connection request from the activated in-home advertising device. The process, at step 408, authenticates the device using data received as part of the connection requests. For instance, in one embodiment, the process determines the physical location of the in-home advertising device using cellular triangulation, GPS, and/or IP address to verify that the in-home advertising device is located in the correct physical location associated with the address of the registered consumer. In one embodiment, if the process determines that the in-home advertising device is located in a different location than the location associated with the address of the registered consumer, the process disables the device at step 410. In such embodiments, the process may display a help number/call center number on the display screen of the in-home advertising device for enabling a person to call for assistance.

In one embodiment of the disclosed invention, an in-home advertising device may be utilized in more than one location. For example, if a consumer moves and transfers residential addresses, the new location of the in-home advertising device may be determined using cellular triangulation, GPS, or IP address. In such an embodiment, in-home advertising device may itself automatically communicate its new location to a server such as advertising device server 130. Advertising device server 130 may then alter the advertisements sent to the consumer in response to the new geographic location associated with the home location of the in-home advertising device. In one embodiment, in-home advertising device may determine its new location each time it is powered on, when a “new home location” or similar option is selected by a user, or after a material change in location is detected. In a similar manner, in-home advertising device may be moved to a vacation home, office, or other location and still operate without having to re-register for the advertising service.

If the process verifies the location of the in-home advertising device, the process, at step 412, retrieves the user profile associated with the registered consumer. At step 414, the process retrieves advertisements based on the retrieved user profile. The process transmits the retrieved advertisements to the in-home advertising device at step 416. The process, at step 418, monitors for user interactivity with the in-home advertising device. For example, the process may receive a purchase request, at step 424, to purchase a good and/or service associated with a displayed advertisement. In this scenario, the process, at step 426, retrieves the billing information associated with the registered consumer and transmits the purchase request to a vendor. In one embodiment, the process, at step 432, bills the vendor for a percentage or flat fee associated with the purchase request.

Alternatively, in some embodiments, the process may, at step 420, receive a request for additional information associated with a good/service corresponding to a displayed advertisement. In these embodiments, the process, at step 422, retrieves the additional information, either locally and/or from a remote network device, and transmits the retrieved additional information to the in-home advertising device.

In one embodiment, the process, at step 428, monitors the network traffic for determining the off-peak traffic times. If the process determines that the network traffic is light, the process, at step 430, retrieves and transmits updated/new content to the in-home advertising device.

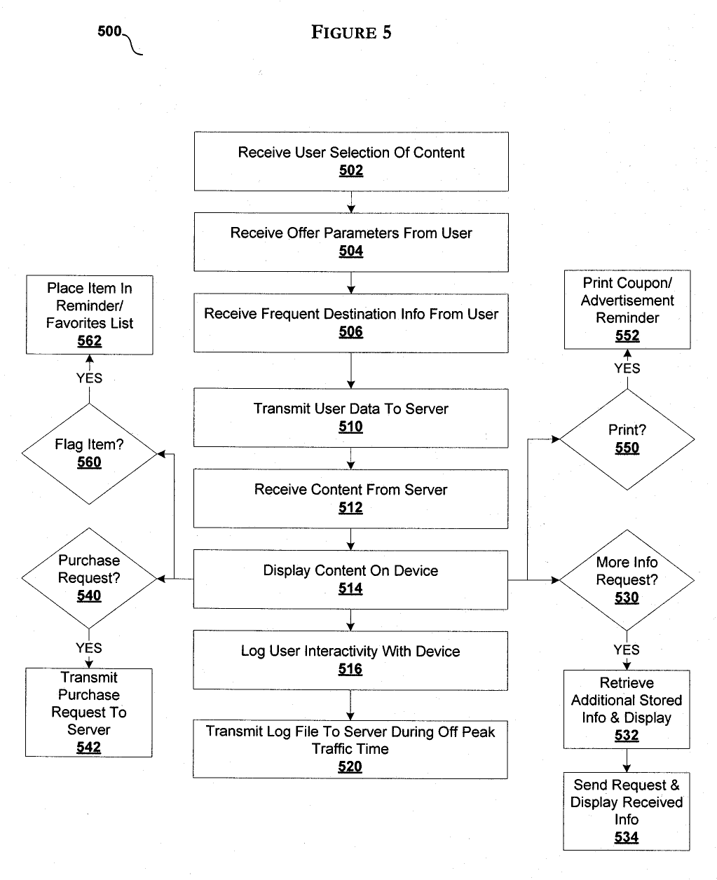

FIG. 5 depicts a process 500 for providing advertising content to a consumer m accordance with certain illustrative embodiments. Process 500 may be executed by an in-home advertising device, such as, but not limited to, in-home advertising device 200 depicted in FIGS. 2 and 3. FIG. 5 begins by receiving user selection of content at step 502. For example, in one embodiment, a user may select advertising content based by category (e.g., clothes, music, travel), by brand (e.g., Nike® shoes), by store name (e.g., Banana Republic®), by location (e.g., with 25 miles from home location), and by topic (hot fashion trends and/or newest tech toys). Additionally, in some embodiments, a user may select a particular date, e.g., anniversary, or a range of dates to receive advertisements and/or coupons associated with events occurring on the specified date and/or within the range of dates.

In addition, in some embodiments, process 500, at step 504, may receive user configured offer parameters. For instance, in one embodiment, a user may configure an in-home advertising device to display all advertising content associated with a selected category. Alternatively, in some embodiments, a user may configure an in-home advertising device to only display advertisements from a selected list (i.e., an opt-in list). Further, in some embodiments, a user may configure an in-home advertising device to not display advertisements from a banned list of advertisers (i.e., an opt-out list). Additionally, in some embodiments, a user may configure an in-home advertising device to receive updates only during a specified period of time and/or only every other day (or any other specified period of time). Further, in some embodiments, a user may configure an in-home advertising device to display each advertisement only a certain number of times and may also configure the display rate for such advertisements.

In addition, in some embodiments, the process, at step 506, may receive one or more frequent destination addresses/places of interest associated with a consumer. For example, in one embodiment, a user may enter a user's work address, a school's address, one or more friends' or relatives' addresses, the address of a local gym, and/or the address of a grocery store. In one embodiment, the process determines the travel route information from the user's home location to the one or more frequent destination addresses and retrieves advertising content associated with businesses along the determined travel routes. In one embodiment, the process interacts with local mapping programs, search software, or Internet resources to determine such travel routes. In one embodiment, the process may interact with a calendar or electronic appointment book to determine a consumer's destinations on a particular day or week. For example, the process may offer certain advertisements based on the day of the week and predicted routes to be taken to church, work, the gym, or another location. The process may also offer certain advertisements based on specific calendar entries or appointments. For example, if a calendar shows a lunch appointment the next day with a client having an address in a neighboring city, the process may select advertisements for restaurant locations near such client's offices. If a calendar shows a planned trip out of town for a vacation or business trip, the process may offer certain advertisements two weeks ahead of time advertising hotels at the trip's location and restaurants an entertainment venues at the trip's location in the days leading up to the scheduled date of departure.

Unlike advertising services that determine your location or predicted route via your wireless telephone or GPS system as you drive to other locations in your car, the disclosed advertising service does not require someone to interact with a system while in transit, which can create safety and distraction issues, as well as practical concerns. Getting a notification of an advertisement as a consumer drives by or towards a particular merchant has a particularly low rate of success, because of the required attention to driving, the inability to recognize when an advertisement is received, and the relatively low likelihood that a consumer will wait until the last minute to plan or change their schedule or their intended destination. One or more embodiments of the present invention address these disadvantages while still achieving the advantages of such systems. By plotting a consumer's likely routes for the next day each night or on an otherwise regular basis, merchants along those routes can still highlight their businesses and options to consumers and display them to the consumer on a convenient device before they leave the house. The advertisements are not received when a consumer is likely to be distracted or occupied while in transit. The advertisements are received far enough in advance to allow planning yet with immediacy and proximity to the transit or travel planned for that day. The advertisements are also not passively displayed on a device that a consumer is unlikely to pay attention to while in transit.

In other embodiments, the process, at step 510, transmits the user configuration information to a network data processing system, such as advertising device server 130, for enabling the network server to process the information and retrieve the appropriate advertising content. In these embodiments, the process, at step 512, receives the appropriate advertising content from the network server. The process, at step 514, displays the received advertisements on the display component of the in-home advertising device. In response to displaying an advertisement, the process monitors for user interactivity with a particular advertisement. For example, in one embodiment, the process, at step 530, may receive a request for additional information associated with a displayed advertisement. If the additional information is stored locally, the process, at step 532, retrieves the store information and displays the information on the display component of an in-home advertising device. Alternatively, if the additional information is not stored locally, the process at step 534 transmits a request for the additional information to a network server and displays the received information.

In some embodiments, the process may, at step 540, receive a request to purchase a good or service corresponding to a displayed advertisement. If the process receives a purchase request at step 540, the process transmits a purchase request to the network server at step 542.

In a preferred embodiment, the process may, at step 550, receive a request to print a coupon and/or an advertisement corresponding to a displayed content. If the process receives a print request, the process prints the coupon and/or advertisement corresponding to the displayed advertisement using the internal printer associated with an in-home advertising device. For example, a user may want to print an advertisement as a reminder to purchase a particular product.

Alternatively, in some embodiments, process 500 may include an option for flagging a particular advertisement. For instance, if the process receives a flag item request at step 560, the process may place the advertisement in a reminder/favorites list at step 562. In some embodiments, a user may configure an in-home advertising device to display advertisements in a reminder/favorites list periodically and/or to display one or more of the advertisements within the reminder/favorites list more often than other advertisements.

Additionally, process 500, at step 516 logs user interactivity with an in-home advertising device. For instance, process 500 may keep a log file of all coupons for a user printed and/or goods/services a user purchases using an in-home advertising device. In one embodiment, the process, at step 520, transmits the log file to a network server during off-peak traffic times. In one embodiment, information on purchases made using coupons printed from an in-home advertising device may also be logged. In such an embodiment, when coupon information is entered via a merchant's point-of-sale systems or otherwise collected by a merchant, such coupon information will include the consumer identifier. When the coupon information is communicated back to an operator of advertising services provided using an in-home advertising device, the coupon information may be combined with the log file previously communicated to the network server, allowing a complete picture of behavior of a consumer's interaction with an in-home advertising device to be obtained.

The logging of consumer behavior facilitates the adoption of various merchant billing models by a provider of advertising services. For example, various weighting of consumer activities may be utilized to bill a particular advertiser. One or more categories of impressions or other consumer activities may be utilized to facilitate such weighting. Such categories may include each time an advertisement is displayed, each time an advertisement is selected or flagged for further follow-up, each time an advertisement is printed, and each time an advertisement is redeemed as a coupon or selected to make a purchase. In one basic embodiment, one point may be assigned for each display, two for each follow-up, three for each printing, and four for each redemption, with the merchant being billed based on the total number of points accumulated for that merchant across a particularly consumer market. Points may be further weighted based on location, household income, order or position of display on an in-home advertising device, purchase amounts when coupons are redeemed, or any other suitable criteria.

Accordingly, certain of the disclosed embodiments present a system and method for providing in-home targeted advertisements to individual consumers. For instance, the disclosed embodiments include an in-home advertising device that enables a user to interact with the in-home advertising device and purchase items with the push of a button. Additionally, in some embodiments, the in-home advertising device may include a built in printer for enabling a user to print an advertised and/or coupon. The disclosed embodiments are described above with reference to flowchart illustrations, sequence diagrams, and/or block diagrams. Each block of the flowchart illustrations and/or block diagrams, and combinations of blocks in the flowchart illustrations and/or block diagrams, may be implemented by computer program instructions. In addition, the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which may include one or more executable instructions for implementing the specified logical function(s).

In some alternative implementations, the functions noted in the block may occur out of the order noted in the figures and/or may be omitted. For instance, in some embodiments, process 500 may alert the appropriate personnel of an unauthorized cellular device without blocking cellular communications associated with unauthorized device. In addition, two blocks shown in succession may, in fact, be executed substantially concurrently, or the blocks may sometimes be executed in the reverse order, depending upon the functionality involved. Further, in some embodiments, each block of the block diagrams and/or flowchart illustration, and combinations of blocks in the block diagrams and/or flowchart illustration, may be implemented entirely with hardware or as a software embodiment (including firmware, resident software, micro-code, etc.) or an embodiment combining software and hardware aspects for performing the specified functions or acts.

Additionally, computer program instructions for executing the disclosed embodiments may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a data processing apparatus to cause a series of operational steps to be performed on the data processing system to produce a computer implemented process such that the instructions which execute on the data processing system provide processes for implementing the functions/acts specified in the flowchart and/or block diagram block or blocks.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The disclosed embodiments were chosen to explain the principles of the invention and the practical application, and to enable others of ordinary skill in the art to understand the invention for various embodiments with various modifications as are suited to the particular use contemplated.

What is claimed is:

1. An in-home advertising device for delivering targeted ads to a user, the advertising device comprising:
a touch screen operable to configure a user profile and further operable to select an advertisement in response to selections of a user;
a printer in communication with the touch screen and operable to print the advertisement in response to the selections of the user, the advertisement operable to be printed with a consumer identifier, the consumer identifier being assigned to the advertising device, the consumer identifier operable to identify the advertising device as being associated with an advertisement that is redeemed with a merchant;
a transceiver operable to communicate with a wireless network, the user profile and the advertisement operable to be communicated over the wireless network using the transceiver, the transceiver having a dedicated telephone number, the transceiver operable to communicate the user profile to the wireless network and receive the advertisement, the advertisement being determined in response to the user profile; and
an impression module in communication with the touch screen and operable to store impression data in response to the advertisement being displayed by the touch screen, selected by a user of the touch screen, or printed by a user of the touch screen, wherein the touch screen, printer, transceiver, impression module, and routing module are contained within a single housing.

2. The advertising device of claim 1, and further comprising a routing module in communication with the touch screen and operable to store location information associated with locations frequented by a user of the advertising device, the location information being used to determine a route of the user, the route being used to further determine the advertisement.

3. The advertising device of claim 1, wherein one of the locations is the location of the advertising device, the location of the advertising device being automatically determined by a remote server.

4. The advertising device of claim 1, wherein one of the locations is the location of the advertising device, the location of the advertising device being automatically determined by a global positioning system.

5. The advertising device of claim 1, wherein one of the locations is the location of the advertising device and wherein the user profile is automatically reconfigured and the advertisement is automatically determined in response to a change in the location of the advertising device.

6. The advertising device of claim 1, wherein one of the locations is the location of the advertising device and wherein the user profile is automatically reconfigured and the route is automatically determined in response to a change in the location of the advertising device.

7. The advertising device of claim 1, wherein the advertising device further includes a calendar module operable to store a calendar associated with the user, the advertisement is further determined in response to entries on the calendar.

8. The advertising device of claim 1, and further comprising a routing module in communication with the touch screen and operable to store primary routes.

9. The advertising device of claim 1, and further comprising a routing module in communication with the touch screen and operable to store secondary routes.

10. The advertising device of claim 1, wherein the impression module tracks different categories of impressions with respect to an advertisement, and wherein each category of impressions is weighted differently and such weight is utilized to determine a fee charged to an advertiser.

11. The advertising device of claim 1, wherein the consumer identifier includes a plurality of identifiers, each of the plurality of identifiers being associated with a different member of a household.

12. The advertising device of claim 1, wherein the impression module tracks different categories of impressions with respect to the aggregate of advertisements displayed via the advertising device, the different categories being used to determine an amount to charge a user of the advertising device.
